(19) United States
(12) Patent Application Publication
(10) Pub. No.: US 2003/0145410 A1
(43) Pub. Date: Aug. 7, 2003

(54) Automated washing apparatus for windowpanes

(76) Inventor: Salvatore Butindari, Torino (IT)

Correspondence Address: YOUNG & THOMPSON, 745 SOUTH 23RD STREET 2ND FLOOR, ARLINGTON, VA, 22202

(21) Appl. No.: 10/343,119

(22) PCT Filed: Jul. 25, 2001
(86) PCT No.: PCT/IT01/00404

(30) Foreign Application Priority Data
Jul. 28, 2000 (IT) TO2000A000748

(51) Int. Cl. B60S 1/46; B60S 1/20

(52) U.S. Cl. 15/250.01; 15/250.24; 15/250.29; 15/250.11; 15/103

(57) ABSTRACT

The present invention consists of an automated washing apparatus for windowpanes, comprising two tracks (7) placed on the sides of a relative windowpane (2), at least one support frame (8) mounted and sliding onto said tracks (7), at least one windscreen wiper (9) supported by the frame (8) and touching the windowpane (2), and a device (10) for moving the frame (8) along the two tracks (7), causing also the windscreen wiper (9) slide against the windowpanes (2). Said moving device (10) is equipped with a sliding element (11) mounted inside each track (7), and a device (24) for actuating the same sliding elements (11). The tracks (7) and the moving device (10) may be either installed in a pre-existing frame (3) or completely included inside said frame (3), so that only the part of the apparatus delimited by the frame (3) is visible from the outside.

### DESCRIPTION

1. Technical Field

The present invention concerns an automated washing apparatus for windowpanes. In particular, it relates to an automated washing apparatus for skyscraper windowpanes. The following description will clearly refer to skyscraper windowpanes but it's not to be considered restrictive.

2. Background Art

Some automated washing systems for skyscraper windowpanes are already known, like the ones described in the U.S. Pat. No. 4,025,984 or in the U.S. Pat. No. 4,809,384, which comprise a support frame mounted and sliding onto two tracks placed on the sides of a series of windowpanes ranged each other, a windscreen wiper firmly supported by the frame and touching the windowpane, and a device for moving the frame along the two tracks, causing also the windscreen wiper slide against the windowpanes.

On the other hand, the U.S. Pat. No. 5,699,576 discloses an automated washing apparatus that has a simpler structure than the previous ones; it comprises two tracks that can be fixed to a windowpane by means of suckers, a support frame mounted and sliding onto the tracks, a windscreen wiper supported by the frame and touching the windowpane, and a device for moving the frame along the relative tracks.

From he above-mentioned patents, one filed a decade after the other since 1977, we can note a tendency to a progressive simplification of automated washing systems. The present invention principally aims at realizing an automated washing apparatus for windowpanes, which has an even simpler structure than the ones above described and at the same time permits to considerably reduce not only maintenance services but even any necessary process for moving the apparatus from one windowpane to another, like in the case of the U.S. Pat. No. 699,576.

### DISCLOSURE OF INVENTION

The present invention supplies an automated washing apparatus for windowpanes, comprising two tracks placed on the sides of a relative windowpane, at least one support frame mounted and sliding onto said tracks, at least one windscreen wiper supported by the frame and touching the windowpane, and a device for moving the frame along the two tracks, causing also the windscreen wiper slide against the windowpanes; this apparatus is characterized by the fact that the moving device is equipped with a sliding element mounted inside each of said tracks; and a device for actuating the same sliding elements. With reference to FIGS. 1 and 4, the whole automated washing apparatus (1) for skyscraper windowpanes (2) is depicted; said windowpanes (2) consist of entire surfaces and are ranged one next to the other in perfect rows. Each windowpane (2), independently or in common with the next windowpanes (2), comprises a support frame (3) consisting of two side closed elements (4), one closed element (5) crossing the two elements (4), and an upper closed horizontal crossbar (6) parallel to the element (5).

The apparatus (1) comprises two tracks (7), fixed to the frame (3) and placed on the sides of a relative windowpane (2), a support frame (8), mounted and sliding onto the tracks (7), two windscreen wipers (9), supported by the frame (8) and touching the windowpane (2), and a device (10) for moving the frame (8) along the two tracks (7), causing also the windscreen wipers (9) slide against the windowpane (2) one parallel to the other.

The tracks (7) and the device (10) may be installed in a pre-existing frame (3), otherwise, as it's depicted in the practical example, they may be completely included inside the frame (3), so that only the part of the apparatus (1) delimited by the frame (8) is visible from the outside.

The device (10) consists of two sliding elements (11) assembled inside each track (7) and delimited by a respective flexible body (12) and at least one respective helical projection (13), which substantially covers the entire relative body (12) and is connected to it.

In addition, the device (10) comprises two sticking ribbons (14), which are inserted inside their respective sites (15) found on the back of the frame (8), at its two opposite ends; as it's depicted in FIG 5, said ribbons are folded up around the relative body (12) forming a U-shape. Each ribbon (14) has a series of central parallel grooves (16) joint to the projection (13) of the body (12), and two end flat flaps (17), laid one over the other, which extend inside the sites (15) and through a longitudinal groove (18) found inside the relative track (7).

As it is depicted in FIG. 3, the groove (18) is found also into the elements (4) in the part towards the inside of the windowpane (2), and allows the ribbons (14) to slide along the elements (4) and the tracks (7).

Each flexible body (12) contains an outgoing arm (20) and a return arm (21) that extend on the sides of the windowpane (2), and a shift arm (22), connected to said arms (20) and (21), which goes across to the same arms (20) and (21) and has a central portion (23) uncovered by the relative track (7).

In the embodiment depicted in FIG. 1, the two tracks (7) have a U-shape and slide across each other, therefore the outgoing arm (20) and the return arm (21) of the same body (12) are placed at the opposite sides of the windowpane (2) and horizontally overlap the return arm (21) and the outgoing arm (20) of the other body (12), while the two arms (22) are placed at a fixed vertical distance one from the other. The frame (8) is supported and moved by the outgoing arms (20) of both the bodies (12).

An automated washing apparatus for windowpanes, consisting of two tracks (7) placed on the sides of a relative windowpane (2), a support frame (8) mounted and sliding into said tracks (7), at least one windscreen wiper (9) supported by the frame (8) and touching the windowpane (2), according to the present invention, comprises:

means to move the frame (8) along the two tracks (7), causing also the windscreen wiper (9) slide against the windowpane (2), by a moving device (10) consisting of a sliding element (11), assembled inside each track (7), which acts on a sticking device (14), placed at the two ends of the frame (8), which supports the windscreen wiper (9) raising and lowering in the two directions the same frame;

means to activate the same sliding elements (11), by a device (24) capable of imposing a movement in one direction or the other opposite to said elements (11).

Conveniently, each sliding element (11) includes a respective flexible body (12) and at least a respective helical projection (13) that substantially covers the entire relative flexible body (12) and is connected to it.

Conveniently, the apparatus comprises two sticking elements (14) in order to fix the frame (8) to each sliding element (11). Each sticking element (14) consists of a ribbon, folded up around the relative flexible body (12) forming a U-shape, which has a series of central parallel grooves (16) joint to the helical projection (13) of the same flexible body (12). Said sticking element is included inside the track (7) at the end of the windowpane, so that only supports (17) where the frame (8) containing the windscreen wiper is installed, extend outwards from the windowpane.

Conveniently, said moving device (10) comprises a transmission (25) interposed between each flexible body (12) and said device (24), in order to transmit a sliding motion to each flexible body (12) by means of the relative helical projection (13). Conveniently, the transmission (25) comprises a gear (26) dynamically joint to each flexible body (12) by means of the relative helical projection (13) that shows a spiral directed backwards compared with the spiral of the other helical projection (13), at least at the level of the same gear (26). Conveniently, the moving system of the apparatus (1) comprises, at each side of the windowpane, a couple of U-shaped tracks (7) containing the sliding element (11), so that each side of the windowpane has an outgoing arm (21) and a return one (20). The frame (8) supporting the windscreen wiper is fixed, by means of a sticking element (14), to the sliding element contained into the arm (20) on one side, and to the sliding element contained into the arm (21) on the other side. In this way, when the device (24) rotates the gear (26) in one direction, the frame (8) slides upwards, while when it rotates backwards, the frame (8) goes down, and the length of the sliding elements remains unchanged.

In the alternative embodiment of the apparatus (1) depicted in FIG. 8, the two tracks (7) involve two windowpanes (2a, 2b) one next to the other, and slide on their sides only for the common portion of the frame (3). The outgoing arm (20) of a body (12) is always placed on the side of a windowpane (2a, 2b), but is vertically ranged with the return arm (21) of the other body (12). In this embodiment, the apparatus (1) comprises two frames (8a, 8b), one for each windowpane (2a, 2b): the first one is supported and moved by the outgoing arms (21), while the second one is supported and moved by the return arms (20). In this solution, the same apparatus (1) is capable of washing simultaneously two windowpanes (2).

In order to move the bodies (12) inside the tracks (7), the moving device (10) is formed by a reversible electric motor (24) placed inside the closed element (5), and by a geared transmission (25) joint to each body (12) at the level of the central portion (23) uncovered by the relative tracks (7), capable of imposing a sliding movement to each body (12) by means of the relative helical projection (13). The transmission (25) includes a gear (26) angularly joint to the projections (13), and the opposite inclination of the spirals of the same projections (13) along the arms (22) makes the relative bodies (12) move in opposite directions along the same arms (22), which is translated however in a sliding movement in the same directions along the arms (20) and (21).

Therefore, in the case depicted in FIG. 1, the frame (8) will move vertically with an outgoing and return motion towards the element (5), while in the case depicted in FIG. 8, the two frames (8) will move simultaneously one parallel to the other. Considering the manufacturing flexibility of the apparatus (1), the motor (24) may be otherwise placed also in the upper closed crossbar (6), making the above-described apparatus (1) substantially symmetrical compared to a median horizontal line of the windowpane (2).

Then, FIG. 4 shows an alternative shape or the apparatus (1), where each windowpane (2) has its own support frame (8) for the windscreen wipers (9) and two parallel tracks (7) placed on the sides of the same windowpane (2) and connected to the tracks (7) of the upper and lower windowpane (2) of the same column. In this case, the apparatus (1) comprises a single motor (24) for the activation of all the sliding elements (11) and its power obviously depends on the number of frames (8) that must be moved at the same time.

According to what is depicted in FIG. 5, at least one or both the flexible bodies (12) are hollow and have an internal channel allowing a washing liquid to reach the frame (8). In particular, the apparatus (1) includes also a washing device (28) that, besides this channel (27), comprises a series of nozzles (29) for the distribution of the washing liquid over the windowpane (2) and a power compressible pump (30).

The nozzles (29) are supported along a lower edge (31) of the frame (8) and are hydraulically connected with the pump (30), which, in its turn, is supported by the frame (8) at an upper edge (32) of the same frame (8) facing the crossbar (6), and is hydraulically connected with the channel (27) in order to supply the washing liquid to the nozzles (29) when it is compressed between the same frame (8) and the crossbar (6).

According to another embodiment that is not depicted, each nozzle (29) may be equipped with a relative pump (30) interposed between the nozzle (29) and the channel (27).

According to what is depicted in FIG. 3, the device (28) includes a reservoir (30a) holding the washing liquid, which is placed near the element (5) and, in its turn, includes a gutter (31), external to the element (5) and supplied with a series of holes (32), and a tank (33) inside the element (5) hydraulically connected to the same holes (32).

The embodiment depicted in FIG. 6 concerns an apparatus (a) similar to the apparatus (1), which differs because the tracks (7) placed at the two sides of the windowpane (2) are not parallel to each other, and the frame (8) contains a novable portion (8a) and a fixed portion (8b) joint to each other by a prismatic track (40) that allows the portion (8a) to slide on the portion (8b) in a crossed direction over the moving direction of the same frame (8).

Each portion (8a, 8b) of the frame (8) supports a respective windscreen wiper (9a, 9b). The portion (8a) that slides onto the track (40) makes the frame (8) adjust its length to the variation of the width of the windowpane (2).

According to what is depicted in FIG. 7, in order to adjust the length of the windscreen wiper (9) to the width of the windowpane (2), both during installation and during operation with windowpanes (2) of irregular outline, each windscreen wiper (9) comprises an adjustable portion (34). In particular, each windscreen wiper (9) has a substantially cylindrical track (35), and the portion (34) consists of a slide (36) joint to the same track (35).

According to an alternative embodiment of the invention that is not depicted, the apparatus (1) may include two couples of tracks (7) placed both inside and outside the windowpane (2) or the windowpanes (2a, 2b). In this way, it's possible to clean both the internal and external surface of each windowpane (2).

The operation of the apparatus (1) and also of all its variants can be easily understood from what has been above described, therefore it does not need further explanations.

Nevertheless, it's important to highlight that it's possible to wash all the windowpanes (2) of a skyscraper (2a) at the same time, by providing each windowpane (2) with its own apparatus (1) and connecting all the moving devices (10) to a central control unit.

In addition, the manufacturing and structure simplicity of the above-described apparatus (1) allows its installation in a lot of windowpanes (2) without any relevant manufacturing problem and, above all, without paying considerable sums of money.

In practice, this invention is not restricted to the above-described and depicted embodiments that are practical examples of the automated washing apparatus (1) for windowpanes, which may, however, vary as regards shape, position of elements, manufacturing and assembling details.

### Brief Description of Drawings

The enclosed drawings are practical examples of the invention, but are not to be considered restrictive:

FIG. 1 is a front elevation view, with some parts in section and other parts hidden for more clarity, showing a first preferred embodiment of the invention of an automated washing apparatus for windowpanes;

FIG. 2 is a perspective view at a larger scale, with some parts in section and other parts hidden for more clarity, of a detail of the apparatus of FIG. 1;

FIG. 3 is a perspective view at a smaller scale, with some parts in section and other parts hidden for more clarity, of a further detail of the apparatus of FIG. 1;

FIG. 4 is a schematic view of a preferred use of the apparatus of FIG. 1;

FIG. 5 is a perspective view at a larger scale, with some parts in section and other parts hidden for more clarity, of a detail of the apparatus of FIG. 1;

FIG. 6 is a schematic view, with some parts hidden for more clarity, of a second preferred embodiment of the apparatus of FIG. 1 in two different functional positions;

FIG. 7 is a perspective view at a larger scale, with some parts in section and other parts hidden for more clarity, of a preferred embodiment of a detail of FIG. 6;

FIG. 8 is a front elevation view, with some parts in section and other parts hidden for more clarity, of a third preferred embodiment of the apparatus of FIG. 1.

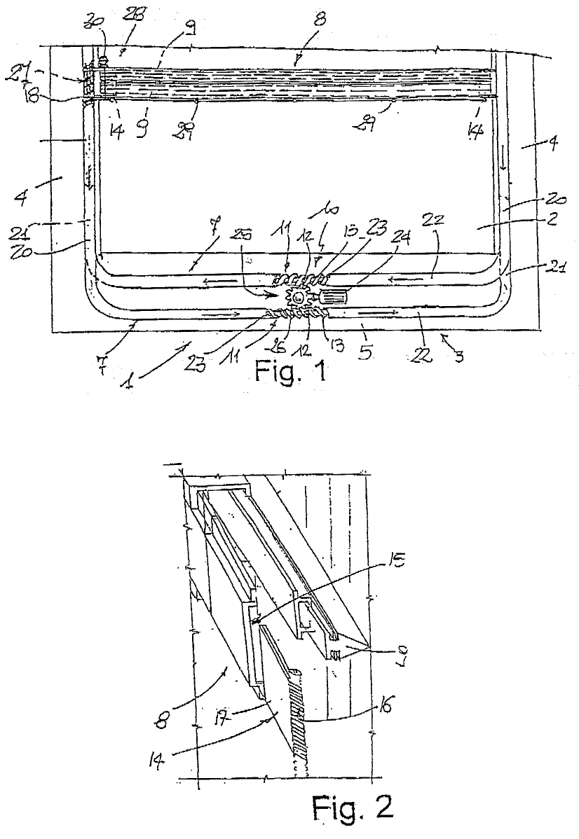

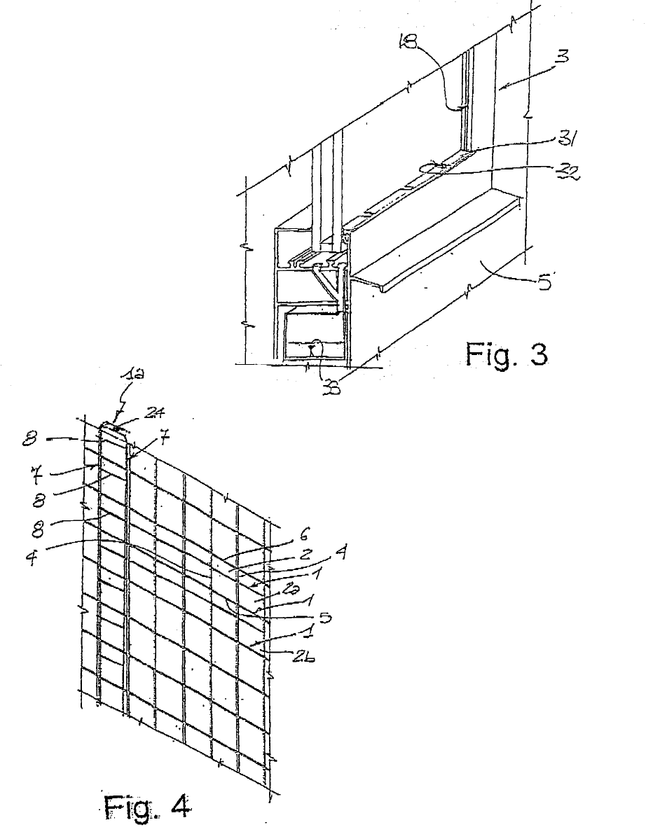

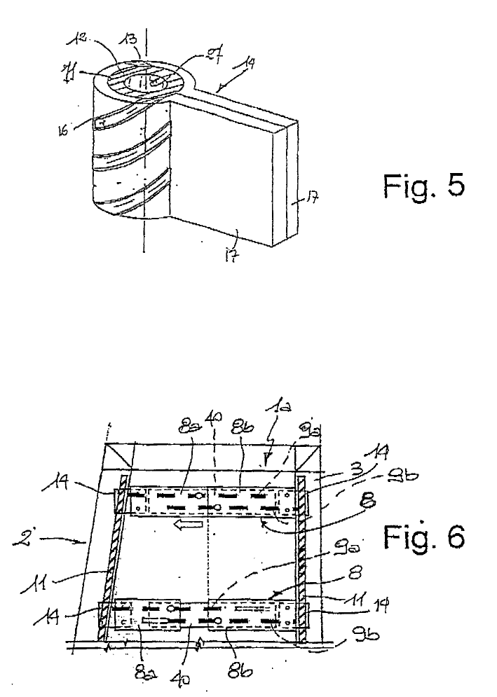

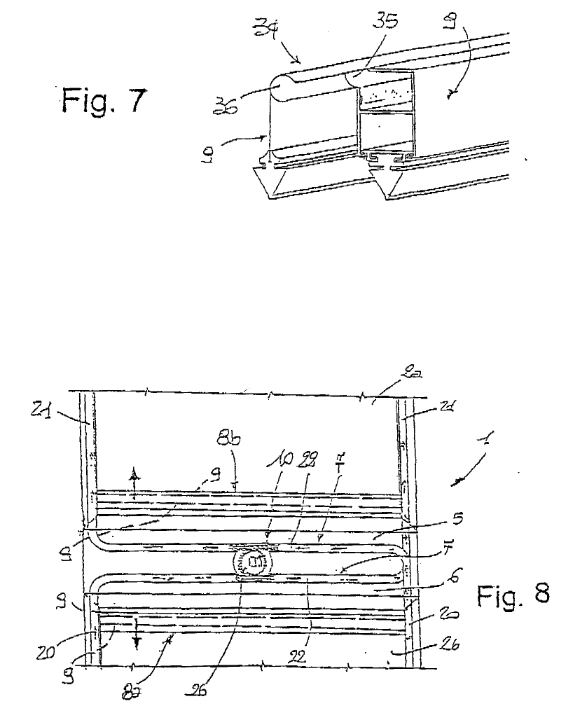

1) Automated washing apparatus for windowpanes, consisting of two tracks (7) placed on the sides of a relative windowpane (2), at least one support frame (8) mounted and sliding onto said tracks (7), at least one windscreen wiper (9) supported by the frame (8) and touching the windowpane (2), characterized by the fact that it comprises:
means to move the frame (8) along the two tracks (7), causing also the windscreen wiper (9) slide against the windowpane (2), by a moving device (10) consisting of a sliding element (11), assembled inside each track (7), which acts on a sticking device (14), placed at the two ends of the frame (8), which supports the windscreen wiper (9) raising and lowering in the two directions the same frame;
means to activate the same sliding elements (11), by a device (24) capable of imposing a movement in one direction or the other opposite to said elements (11), by acting on a device (26) connected to it.

2) Apparatus according to claim 1, characterized by the fact that each sliding element (11) includes a respective flexible body (12) and at least a respective helical projection (13) that substantially covers the entire relative flexible body (12) and is connected to it.

3) Apparatus according to claim 2, characterized by the fact that each flexible body (12) contains an outgoing arm (20) and a return arm (21) that extend on the sides of the windowpane (2), and a shift arm (22), connected to said arms (20) and (21), which goes across to the same arms (20) and (21) and has a central portion (23) uncovered by the relative track (7).

4) Apparatus according to claim 1, characterized by the fact that the tracks (7) are two on each side of the windowpane, they have a U-shape and slide across each other, therefore the outgoing arm (20) and the return arm (21) of the same body (12) are placed at the opposite sides of the windowpane (2) and horizontally overlap the return arm (21) and the outgoing arm (20) of the other body (12), while the two arms (22) are placed at a fixed vertical distance one from the other. The frame (8) is supported and moved by the outgoing arms (20) of both the bodies (12).

5) Apparatus according to claim 1 or 2, characterized by the fact that said apparatus (1) comprises two sticking elements (14) in order to fix the frame (8) to each sliding element (11). Each sticking element (14) consists of a ribbon, folded up around the relative flexible body (12) forming a U-shape, which has a series of central parallel grooves (16) joint to the helical projection (13) of the same flexible body (12). Said sticking element is included inside the track (7) at the end of the windowpane, so that only the supports (17) where the frame (8) containing the windscreen wiper is installed, extend outwards from the windowpane.

6) Apparatus according to claim 1, characterized by the fact that said moving device (10) comprises a transmission (25) interposed between each flexible body (12) and said device (24), in order to transmit a sliding motion to each flexible body (12) by means of the relative helical projection (13).

7) Apparatus according to claim 6, characterized by the fact that the transmission (25) comprises a gear (26) dynamically joint to each flexible body (12) by means of the relative helical projection (13) that shows a spiral directed backwards compared with the spiral of the other helical projection (13), at least at the level of the same gear (26).

8) Apparatus according to claim 1, 2 or 6 characterized by the fact that the moving system of the apparatus (1) comprises, at each side of the windowpane, a couple of U-shaped tracks (7) containing the sliding element (11), so that each side of the windowpane has an outgoing arm (21) and a return one (20). The frame (8) supporting the windscreen wiper is fixed, by means of a sticking element (14), to the sliding element contained into the arm (20) on one side, and to the sliding element contained into the arm (21) on the other side. In this way, when the device (24) rotates the gear (26) in one direction, the frame (8) slides upwards, while when it rotates backwards, the frame (8) goes down, and the length of the sliding elements remains unchanged.

9) Apparatus according to claim 8, characterized by the fact that said apparatus (1) comprises two frames (8a, 8b) and at least one windscreen wiper (9) for each frame (8); the first one (8b) of said two frames (8a, 8b) is supported and moved by the two outgoing arms (20), while the second one (8a) is supported and moved by the two return arms (20).

10) Apparatus according to claim 1, characterized by the fact that the frame (8) contains two portions (8a, 8b) movable to each other and joint to a track (40) in a crossed position over a moving direction of the same frame (8); each portion (8a, 8b) supports a respective windscreen wiper (9a, 9b).

11) Apparatus according to claim 1, characterized by the fact that the windscreen wiper (9) comprises an adjustable portion (34), in order to adjust the length of the windscreen wiper (9) to the width of the windowpane (2).

12) Apparatus according to claim 1, characterized by the fact that the moving device (10) is included inside a support frame (3) of the windowpane (2).

13) Apparatus according to claim 1, characterized by the fact that said apparatus (1) comprises a series of nozzles (29) for the distribution of the washing liquid over the windowpane (2) or for the vaporization of the product; the nozzles (29) are supported along said frame (8) and are hydraulically connected with a channel (27).

14) Apparatus according to claim 13, characterized by the fact that said apparatus (1) comprises at least a power compressible pump (30), supported by said frame (8) and interposed between said channel (27) and said nozzles (29) in order to supply the washing liquid to the same nozzles.

15) Apparatus according to claim 13, characterized by the fact that said apparatus (1) includes a series of reservoirs (30a) holding the washing liquid, which are placed near a closed base (5) of said frame (3), comprising a gutter (31), external to the base (5) and supplied with a series of holes (32), and a tank (33) inside the base (5) hydraulically connected to the same holes (32).

16) Apparatus according to claim 1, characterized by the fact that said tracks (7) are placed on the opposite sides of a series of windowpanes (2) ranged each other; the sliding elements (11) are connected in series to each other and to the moving device (10) and comprise a single motor (24) for the activation of all the sliding elements (11) onto the same tracks (7).
